(19) United States
(12) Patent Application Publication
(10) Pub. No.: US 2002/0178801 A1
(43) Pub. Date: Dec. 5, 2002

(54) Self-detecting type SPM probe

(76) Inventors: Hiroshi Takahashi, Chiba-shi (JP); Yoshiharu Shirakawabe, Chiba-shi (JP); Tadashi Arai, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/153,530

(22) Filed: May 22, 2002

(30) Foreign Application Priority Data
May 31, 2001 (JP) 2001-165306

(51) Int. Cl. G01B 5/28

(52) U.S. Cl. 73/105

(57) ABSTRACT

The present invention provides a self-detecting SPM probe constructed from a cantilever provided with a piezoresistance and typified by a self-detecting type SPM probe that does not generate leakage current while measuring a surface potential of a sample.

Insulation between a conductive layer 22 and a piezoresistance 20 increases by depositing an oxide layer 17 between the conductive layer 22 coated on in the vicinity of a tip 12 and the tip 12.

### BACKGROUND OF THE INVENTION

1. Field of the invention

The present invention relates to self-detecting type SPM probes, and more particularly relates to self-detecting type SPM probes detecting bending of a cantilever using a piezoresistance and applicable to measuring surface potential of a sample.

2. Description of the Prior Art

Currently, Scanning Probe Microscopes (SPMs) are used for observing minute regions in the order of nanometers at a sample surface. Amongst these SPMs, Atomic Force Microscopes (AFMS) employing cantilevers provided with tips at a front end as scanning probes are particularly noted.

Atomic Force Microscopes measure the shape of the surface of a sample by detecting interatomic force (force of attraction or force of repulsion) generated between the surface of the sample and the tip as an amount of bending of a cantilever as the cantilever tip scans along the surface of a sample. Optical methods and the self-detecting types exist as different methods for measuring the amount of bending at the cantilever.

With cantilevers employing optical methods (referred to in the following as “optical method cantilevers”), the cantilever is irradiated with laser light and the amount of bending is detected by measuring changes in the angle of reflection. Further, by making the tip of the optical method cantilever conductive and then applying a voltage across the tip and the sample surface, changes in the amount of bending can be measured based on changes in current flowing between the tip and the sample surface or based on electrostatic capacitance induced by this applied voltage.

However, optical method cantilevers required fine adjustment of the angle of irradiation of laser light irradiated towards the cantilever and the position of a photodiode for detecting light reflected from the cantilever etc. In particular, there is the complexity that it is necessary to repeatedly carry out fine adjustment while frequently changing the cantilevers, which has caused attention to be paid to self-detecting type SPM probes.

With self-detecting cantilevers (hereinafter referred to as “self-detecting type SPM probes”), a piezoresistance is formed at the cantilever, and the amount of bending is detected by measuring changes in the value of this resistance. It is, however, necessary to form a wiring pattern for extracting changes in voltage from the piezoresistance with self-detecting type SPM probes. It has therefore proved difficult to provide a cantilever that is conductive overall but which includes a tip that does not make contact with the wiring pattern.

Self-detecting SPM probes have therefore been developed that detect the amount of bending of a cantilever using a piezoresistance provided at the cantilever and measure the surface potential of a sample.

FIG. 11 is a plan view of a facing side of a sample for a related self-detecting type SPM probe. This self-detecting type SPM probe 110 (hereinafter referred to as an “SPM probe”) comprises a cantilever shape formed by coupling a lever provided with a tip 112 at a front end and a support unit using three bending parts. Two of the three bending parts are formed symmetrically either side of a central line constituted by a straight line along the lengthwise direction of the SPM probe 110 in such a manner that the tip 112 passes through. A U-shaped piezoresistance 120 is formed at these bending parts so as to enter the lever by passing through one of the bending parts from the support unit of the SPM probe 110 and be taken from the support unit by passing through the other bending units.

An insulating layer (not shown) is also formed on the piezoresistance 120 and the support unit. On the insulating layer, conductive layers 126 and 128 constituting wiring are formed in such a manner as to be overlaid from a portion positioned at the support unit of the piezoresistance 120 to a portion of the support unit where the piezoresistance 120 is not formed. Ends of the conductive layers 126 and 128 positioned at the piezoresistance 120 and the piezoresistance 120 at the lower layer are electrically connected by contact parts 132 and 134, respectively.

Of the three bending parts, the remaining one on which the piezoresistance 120 is not formed is formed at the upper part of the central line. A conductive layer 124 is formed on this bending part from the tip 112 to the support unit of the SPM probe 110. The surface layer side of the tip 112 is coated directly with a conductive film 122. The conductive film 122 and an end of the conductive layer 124 are electrically connected. A conductive layer 124 sandwiches an insulating layer so that there is insulation from the piezoresistance 120.

FIG. 12 is a cross-sectional view taken along line A-A′ of FIG. 11. As shown in FIG. 12 (refer to FIG. 11), the aforementioned SPM probe 110 is formed by forming an embedded oxide layer (SiO₂) 114 on a semiconductor substrate 115 formed of silicon and then thermally pasting a silicon layer 116 on the oxide layer 114 using Silicon on Insulator (SOI) technology. A highly-insulating element separator is also implemented between portions positioned at the support part of the piezoresistance 120 using SOI technology.

As shown in FIG. 12, the support unit of the SPM probe 110 takes a semiconductor substrate 115 formed on the surface of the oxide layer 114 as a substrate, with the silicon layer 116 then being formed on the oxide layer 114. In particular, at the support unit of the SPM probe 110, the silicon layer 116 is separated into three regions, with the ends of the piezoresistance 120 being formed in two of these regions. As described above, both ends of the piezoresistance 120 are connected to the metal contacts 132 and 134. The lever of the SPM probe 110 takes the silicon layer 116 coupled to the support unit via the three bending parts as a substrate.

An oxide layer 117 is also formed on the surface of the silicon layer 116 at the piezoresistance 120 and the support unit with the exception of the metal contact parts 132 and 134. This oxide layer 117 corresponds to the aforementioned insulation layer. The aforementioned conductive layers 126 and 128 are formed on the oxide layer 117.

FIG. 13 is a cross sectional view taken along line B-B′ in FIG. 11. As shown in FIG. 13, the conductive layer 124 is arranged so as to pass through from the conductive film 122 covering the tip 112 , through the silicon layer 116 constituting the substrate of the lever, and the oxide layer 117 formed on the silicon layer 116 at the piezoresistance 120 and the support unit. One end of the conductive layer 124 and one part of the conductive film 122 are electrically connected taking the conductive film 122 as a lower layer.

A structure where it is possible to apply a voltage across the tip 112 and the sample surface (not shown) can therefore be achieved by taking the sample to be observed by an SPM microscope as one electrode and by taking the conductive layer 124 positioned at the support unit of the SPM probe 110 as another electrode.

With related self-detecting type SPM probes, conductivity is brought about by covering the surface of the tip with conductive film and electrode wiring is taken from this conductive film to give one electrode so that a voltage can then be applied across the sample taken as the other electrode and the tip. The lever of the SPM probe and the support part are coupled by three bending parts and a U-shaped piezoresistance is formed so as to pass through two of these bending parts. The remaining bending part is formed from the vicinity of the tip along the support unit so as to electrically connect the conductive layer and the tip. This enables the amount of bending of the cantilever to be detected by the piezoresistance and allows a potential to be applied to the tip. The other end of the conductive layer, one end of which electrically connects with the tip, is guided to the support unit of the SPM probe and is electrically connected with an external circuit for applying a potential to the tip.

However, with the related self-detecting SPM probe, as shown by the arrows in FIG. 13, in the case of actual manufacture a problem occurs where leakage current flows as crosstalk between the conductive film 124 taken as the electrode wiring formed at the conductive body 122 covering a portion of the tip 112 and the lever and the piezoresistance 120. It can be understood that this leakage current is particularly large when the sample is irradiated with light.

Normally, a self-detecting type SPM is theoretically not used in such a manner that a sample surface is irradiated with light. However, in the case of self-detecting type SPMs used in measuring surface potential of a sample, measurements are not only carried out without irradiating the sample surface with light, and it is also necessary to take measurements with the surface of the sample being irradiated with light. At this time, measurement cannot be reliably carried out when the leakage current flows in the manner described above.

In the following, characteristics when leakage current flows between the conductor, the conductive film and the piezoresistance are described for the case of measuring without irradiating the surface of a sample with light (in the dark) and when measuring with the sample surface irradiated with light (in the light). A graph of current against voltage for between the conductor, conductive film and piezoresistance for a related SPM probe is shown in FIG. 14.

This current-voltage graph is plotted for measurements of leakage current with respect to voltage taking the current (A) as the vertical axis and the voltage V(V) as the horizontal axis. Specifically, in FIG. 11, a graph is shown for when leakage current flowing between the conductor 122, the conductive film 124 and the piezoresistance 120 is measured with a variable voltage being applied to the conductor 122 covering the tip 112 with the conductive layers 126 and 128 put to ground, i.e. with the piezoresistance 120 put to ground. The voltage can be varied between −5V and 5V.

At this I-V graph, changes from −5V to −0.5V are substantially the same for a curve D for in the dark and a curve P for in the light. There is, however, a difference in that there is a current of approximately 14.44 nA during darkness and a current of approximately 1,170 mA during light. The leakage current flowing in the dark is of a value small enough to be ignored and the leakage current flowing in the light is also quite small but is a significantly large value for SPMs requiring a spatial resolution of less than approximately 100 nm and is therefore of a value that influences measurements.

With the related structure for a self-detecting type SPM probe where leakage current that influences measurements flows, in addition to the cantilever itself being quite small, the lever is quite small compared with the support unit. Further, as silicon has a high resistance, if the oxide film 116 is formed as insulation between the conductive layers 126 and 128 connected to the piezoresistance 120 and the conductive film 124 taken as electrical wiring, it is not possible to predict where other crosstalk may occur.

Each layer of a self-detecting type SPM probe is a thickness of an order of microns. It is, however, difficult to grasp an understanding of the characteristics occurring between each layer, and if an actual structure is measured, it is difficult to understand the generation of leakage current. Further, the self-detecting type SPM requires a spatial resolution of the extent described above and it is necessary to sharpen the tip in order to obtain this spatial resolution. This requires the volume of the tip to be small, which paradoxically makes understanding of the generation of leakage current difficult to understand.

Here, “paradoxically” means contrary to the demand for keeping the volume small to provide sharpness, although the structure of the present invention is described in detail in the following.

In order to resolve the problems of the related art, it is the object of the present invention to provide a self-detecting type SPM probe typified by a self-detecting type SPM probe where leakage current does not occur that can be applied to detecting an amount of bending of a cantilever using a piezoresistance provided at a cantilever and measuring surface potential of a sample.

### SUMMARY OF THE INVENTION

In order to resolve the aforementioned problems and achieve the object, there is provided a self detecting type SPM probe formed from a lever provided with a cantilever comprising a sharpened tip at a front end thereof, a support unit supporting the lever, bending parts coupling the lever and the support unit, a piezoresistance formed in a U-shape provided on the cantilever so as to pass through the bending parts, a conductive film coated in the vicinity of the tip, an insulation layer formed on the piezoresistance and the support unit, and a conductive layer electrically connecting with the conductive film in the vicinity of the tip of the conductive film and overlaid so as to pass from the lever, through the bending parts so as to reach the support unit, characterized by an insulation layer being laminated between the conductive film coated in the vicinity of the tip and the tip.

According to claim 1 of this invention, a conductive film of the tip and the vicinity thereof are insulated from a piezoresistance by a silicon oxide film. Electrode wiring is then taken from the conductive layer covering the surface of the tip and is taken as one electrode so that when a voltage is applied across a sample constituting the other electrode and the tip, leakage current between the conductive layer of the tip, the vicinity thereof, and the piezoresistance that is small compared to that of the related art can be obtained. In particular, an SPM can be provided whereby the leakage current in a bright environment where the sample is irradiated with light is a small value which is substantially the same as leakage current for when the sample is in the dark and is not irradiated with light. This means that data taken both in the light and in the dark can be compared.

An insulation layer laminated between the conductive layer, covering the tip and the vicinity of the tip, and the tip may also be an insulating layer formed on the piezoresistance and the support unit in an overlaid manner. The insulation layer laminated between the conductive layer, covering the tip and the vicinity of the tip, and the tip may also be an insulating layer formed on the piezoresistance and the support unit in a thin manner.

The conductive layer may also be provided above or below the conductive film at a portion electrically connecting the conductive layer and the conductive film, and the conductive layer and the conductive film may be laminated in an integral manner.

The self-detecting SPM probe of this invention may not just be an AFM, and a Kelvin Probe Force Microscope (KFM) or a Scanning Maxwell Stress Microscope (SMM) may also be used as a microscope for measuring surface potential etc. of a sample surface by applying a voltage across the tip and the sample surface.

### BRIEF DESCRIPTION OF THE DRAWINGS

FIG. 1 is a plan view of a facing side of a sample for a self-detecting type SPM probe of a first embodiment of the invention.

FIG. 2 is a cross-sectional view taken along line A-A′ of FIG. 1 relating to the first embodiment.

FIG. 3 is a cross-sectional view taken along line B-B′ of FIG. 1 relating to the first embodiment.

FIG. 4A-FIG. 4L area views illustrating the steps of the processes for forming the self-detecting type SPM probe of the first embodiment.

FIG. 5 is graph of current against voltage for between the conductor, conductive film and piezoresistance for an SPM probe of the first embodiment.

FIG. 6 is graph of current against voltage for between the conductor, conductive film and piezoresistance for an SPM probe of the first embodiment.

FIG. 7 is a cross-sectional view corresponding to line B-B′ of FIG. 1 for a modified example of the first embodiment.

FIG. 8A-FIG. 8C are views illustrating a part of the steps of the processes for forming the SPM probe of the modified example of FIG. 7.

FIG. 9 is a cross-sectional view corresponding to line B-B′ of FIG. 1 for a second embodiment.

FIG. 10A-FIG. 10D are views illustrating a part of the steps of the processes for forming the SPM probe of the second embodiment of FIG. 9.

FIG. 11 is a plan view of a facing side of a sample for a related self-detecting type SPM probe.

FIG. 12 is a cross-sectional view taken along line A-A′ of FIG. 11.

FIG. 13 is a cross-sectional view taken along line B-B′ of FIG. 11. FIG. 14 is graph of current against voltage for between the conductor, conductive film and piezoresistance for an SPM probe of the related art.

### DETAILED DESCRIPTION OF THE PREFERRED EMBODIMENTS

The following is a detailed description, based on the drawings, of preferred embodiments of an SPM probe of the present invention. It should be understood that the present invention is not limited to this embodiment.

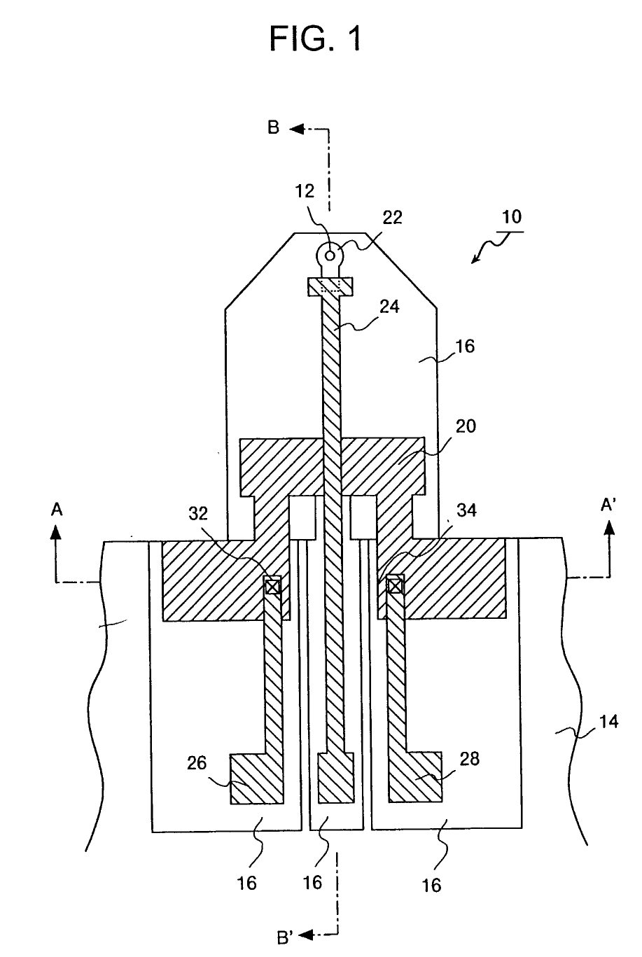

FIG. 1 is a plan view of a facing side of a sample for a self-detecting type SPM probe of a first embodiment of the invention. A self-detecting type SPM probe 10 (hereinafter referred to as an “SPM probe”) comprises a cantilever shape formed by coupling a lever provided with a tip 12 at a front end and a support unit using three bending parts. Two of the three bending parts are formed symmetrically either side of a central line constituted by a straight line along the lengthwise direction of the SPM probe 10 in such a manner that the tip 12 passes through. A U-shaped piezoresistance 120 is formed at these bending parts so as to enter the lever by passing through one of the bending parts from the support unit of the SPM probe 110 and be taken from the support unit by passing through the other bending units.

An insulating layer (not shown) is also formed on the piezoresistance 20 and the support unit. On the insulating layer, conductive layers 26 and 28 constituting wiring are formed in such a manner as to be overlaid from a portion positioned at the support unit of the piezoresistance 20 to a portion of the support unit where the piezoresistance 20 is not formed. Ends of the conductive layers 26 and 28 positioned at the piezoresistance 20 and the piezoresistance 20 at the lower layer are electrically connected by contact parts 32 and 34, respectively.

Of the three bending parts, the remaining one on which the piezoresistance 20 is not formed is formed at the upper part of the central line. A conductive layer 24 is formed on this bending part from the tip 12 to the support unit of the SPM probe 10 so as to sandwich an insulating layer 17. The tip 12 is covered by the conductive film and the tip 12 and an end of the conductive layer 24 are electrically connected.

Of the three bending parts, the remaining one on which the piezoresistance 20 is not formed is formed at the upper part of the central line. The conductive layer 24 is formed on this bending part from the tip 12 to the support unit of the SPM probe 10. The surface layer side of the tip 12 is coated with a conductive film 22 via an insulating layer (described later). The conductive film 22 and an end of the conductive layer 24 are electrically connected. A conductive layer 24 sandwiches an insulating layer so that there is insulation from the piezoresistance 20.

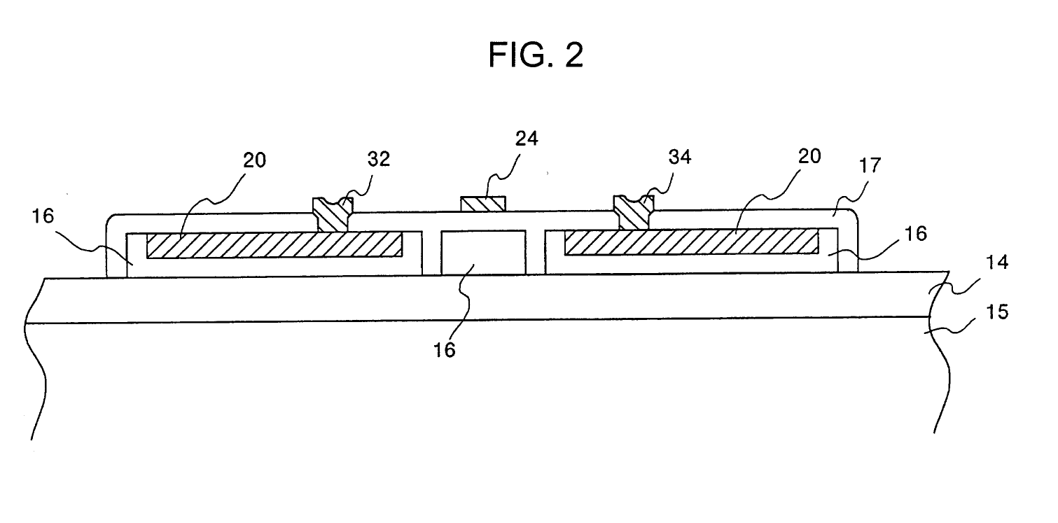

FIG. 2 shows a cross-sectional view along line A-A′ of FIG. 1, and as shown in FIG. 2, the SPM probe 10 is formed by forming an embedded oxide layer (SiO₂) 14 on a semiconductor substrate 15 formed of silicon and then thermally pasting a silicon layer 16 on the oxide layer 14 using Silicon on Insulator (SOI) technology. A highly-insulating element separator is also implemented between portions positioned at the support part of the piezoresistance 20 using SOI technology.

FIG. 2 is a cross-sectional view taken along line A-A′ of FIG. 1. As shown in FIG. 2 (refer to FIG. 1), the SPM probe 10 is formed by forming an embedded oxide layer (SiO₂) 14 on a semiconductor substrate 15 formed of silicon and then thermally pasting a silicon layer 16 on the oxide layer 14 using Silicon on Insulator (SOI) technology. A highly-insulating element separator is also implemented between portions positioned at the support part of the piezoresistance 20 using SOI technology.

As shown in FIG. 2, the support unit of the SPM probe 10 takes a semiconductor substrate 15 formed on the surface of the oxide layer 14 as a substrate, with the silicon layer 16 then being formed on the oxide layer 14. In particular, at the support unit of the SPM probe 10, the silicon layer 16 is separated into three regions, with the ends of the piezoresistance 20 being formed in two of these regions. As described above, both ends of the piezoresistance 20 are connected to the metal contacts 32 and 34. The lever of the SPM probe 10 takes the silicon layer 16 coupled to the support unit via the three bending parts as a substrate.

An oxide layer 17 is also formed on the surface of the silicon layer 16 at the piezoresistance 20 and the support unit with the exception of the metal contact parts 32 and 34. This oxide layer 17 corresponds to the aforementioned insulation layer. The aforementioned conductive layers 26 and 28 are formed on the oxide layer 17. Further, the oxide layer 17 is formed integrally so as to be overlaid with an insulation layer between the tip 22 and the conductive layer 24, as described later.

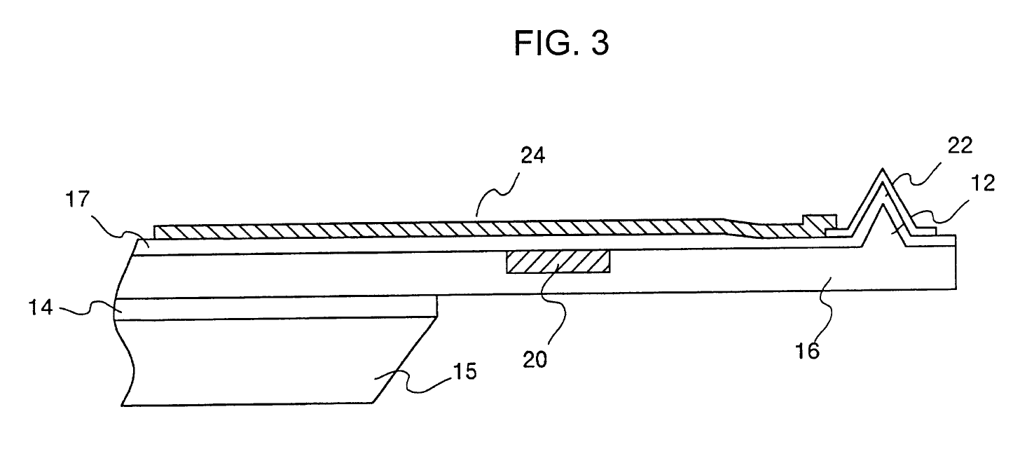

FIG. 3 is a cross sectional view taken along line B-B′ in FIG. 1. As shown in FIG. 3, the conductive layer 24 is arranged so as to pass through from the conductive film 22 covering the tip 12 via the oxide layer 17, through the silicon layer 16 constituting the substrate of the lever, and the oxide layer 17 formed on the silicon layer 16 at the piezoresistance 20 and the support unit. One end of the conductive layer 24 and one part of the conductive film 22 are electrically connected taking the conductive film 22 as a lower layer. The oxide layer 17 is laminated in such a manner that a portion of the tip 12 (conductive film 22) is thinner than a portion of the conductive layer 24. The oxide layer 17 is formed so as to have a region that becomes gradually thinner from the center of the lever towards the side of the tip 12 where the conductive layer 24 is formed.

A structure where it is possible to apply a voltage across the tip 12 and the sample surface (not shown) can therefore be achieved by taking the sample to be observed by an SPM microscope as one electrode and by taking the conductive layer 24 positioned at the support unit of the SPM probe 10 as another electrode. The conductive layer 14 is insulated from the piezoresistance 20 via the oxide layer 24. The conductive film 22 is insulated from the piezoresistance 20 via the oxide layer 24.

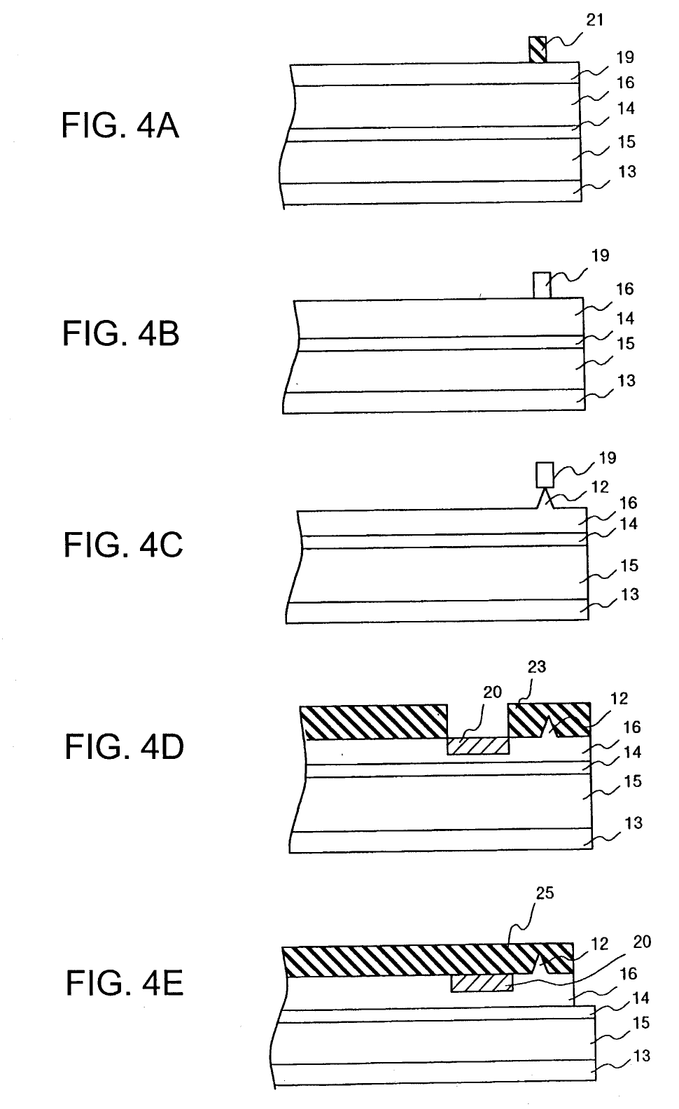

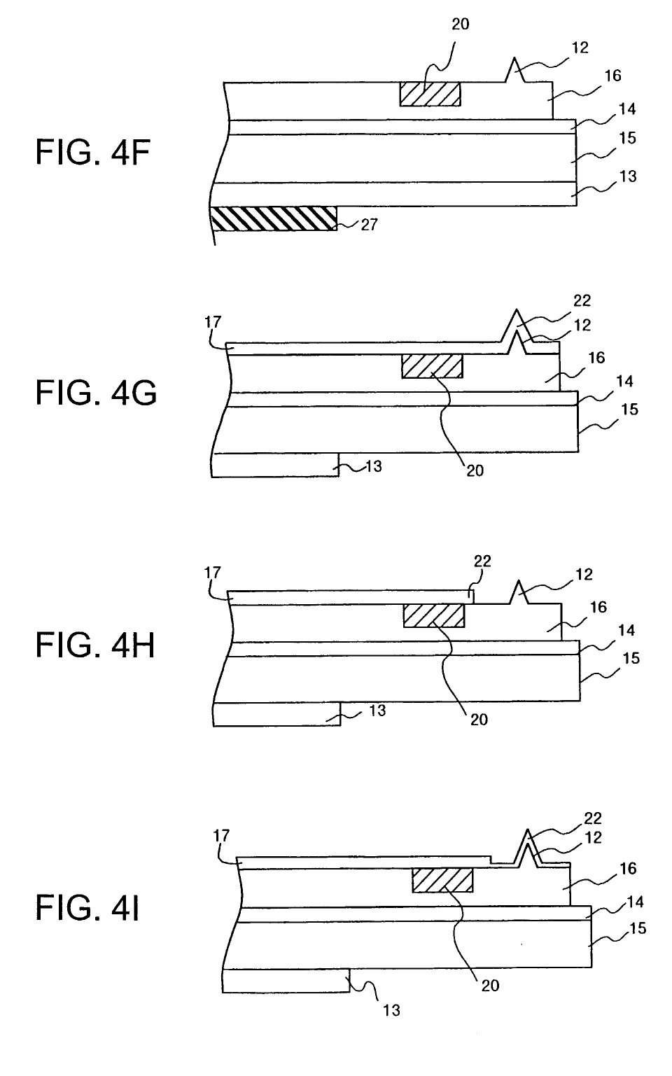

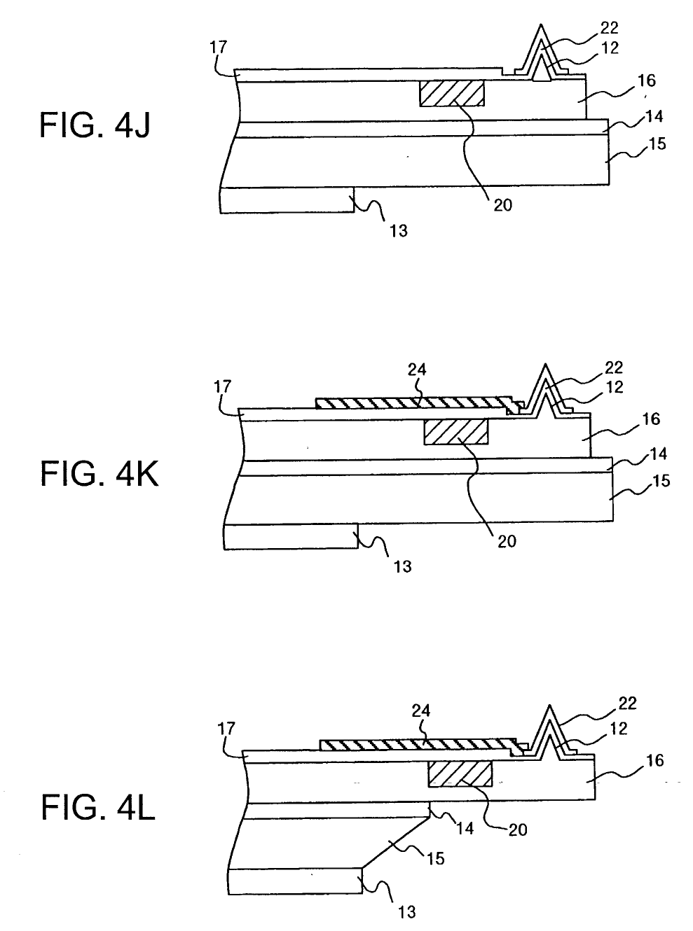

Next, processes for forming the SPM probe 10 shown in FIG. 1 are described. Cross-sections of the processes for forming the SPM probe 10 along line B-B′ of FIG. 1 are shown in FIG. 4A-FIG. 4L.

As shown in FIG. 4A, an embedded oxide layer (SiO₂) 14 is formed on a semiconductor substrate 15 formed of a silicon substrate and a sandwich structure SOI substrate is formed by thermally pasting the n-type SOI silicon layer 16 onto the embedded oxide layer 14. Silicon oxide films (SiO2) 19 and 13 are then formed by thermally oxidizing the surface and rear surface of the SOI substrate, and a photoresist film 21 constituting an etching mask is patterned onto the silicon oxide film 19.

Next, as shown in FIG. 4B, a silicon oxide film (SiO2) 19 is patterned as a mask for forming the tip by solubly etching the silicon oxide film 19 using buffered hydrofluoric acid (BHF) taking the photoresist 21 as a mask.

Next, as shown in FIG. 4C, a sharpened tip 12 is formed below the mask 19 by carrying out reactive ion etching (RIE) taking the patterned silicon oxide film 19 as a mask.

Further, as shown in FIG. 4D, an opening is made in the region where the piezoresistance is formed in the surface of the semiconductor substrate 16 and a photoresist film 23 is formed. A p+ piezoresistance region, i.e. the piezoresistance 20 is then formed by injecting ions into the open portion.

Next, the photoresist film 23 is removed and a cantilever-shaped photoresist film 25 is formed on the SOI silicon layer 16 as shown in FIG. 4E. The SOI silicon layer 16 is then etched using RIE down to the embedded oxide layer 14 taking the photoresist film 25 as a mask and an end of the cantilever is formed.

As shown in FIG. 4F, the photoresist layer 25 is removed and a photoresist film 27 constituting an etching mask is formed below the rear surface side silicon oxide film (SiO2) 13. Back-etching is then carried out using buffered hydrofluoric acid (BHF) taking the photoresist film 27 as a mask and the silicon oxide film 13 is formed by patterning.

Further, as shown in FIG. 4G, the silicon oxide film is coated on from the support part of the SOI silicon layer 16 to the region for forming the piezoresistance 20 at the lever and to the tip 12 so as to protect the surface. As shown in FIG. 4H, the silicon oxide film 17 for the portion for the tip 12 is peeled away, and as shown in FIG. 4I, a silicon oxide film 17 that is thinner than the silicon oxide film 17 for the previous time covers the tip 12.

Further, as shown in FIG. 4J, the surface and the outside edge of the silicon oxide film 17 of the tip 12 is covered with relatively hard titanium (Ti) or platinum (Pt) so as to form the conductive film 22. It is preferable for the thickness of the conductive film 22 to be thin to as great an extent as possible whereby the pointedness of the tip is not lost.

For example, approximately 10 nm to 100 nm is preferable. A thickness of approximately 10 nm is a thickness where there is no electrical breakdown when a voltage of around 10V is applied across the sample and the tip 12. A thickness of approximately 100 nm is substantially the limit for obtaining a spatial resolution of approximately 100 nm for an atomic force microscope. A thickness of this range is thinner than the 500 nm to 800 nm thickness typically demanded as a thickness of a silicon oxide film formed on a semiconductor substrate.

Next, as shown in FIG. 4K, the conductive layer 24 is formed from a metal such as aluminum (Al) etc. so as to be relatively thick from the tip 12, along the bending part and continuing on to the support unit, and onto an end of the conductive film 22. One end positioned at the lever of the conductive layer 24 and one part of the conductive film 22 are electrically connected taking the conductive film 22 as a lower layer. During this time, a portion positioned at the support unit of the piezoresistance 20 is not coated with the silicon oxide film 17. Aluminum (Al) etc. is embedded at this portion so as to form metal contacts 32 and 34 and conductive layers 26 and 28 are formed as wiring from the metal contacts 32 and 34 taking the silicon oxide film 17 as a lower layer (not shown).

Next, as shown in FIG. 4L, back-etching is carried out using a 40% potassium hydroxide solution (KOH+H2O) taking the patterned silicon oxide film 13 as a mask as shown in FIG. 4G, the semiconductor substrate 15 and embedded oxide layer 14 are removed in a localized manner, and an SPM probe 10 consisting of an SOI silicon layer 16 equipped with a piezoresistance 20 and a conductive layer 24 is formed.

Here, p+ ions are injected into an n-type silicon layer 16 and a P+ piezoresistance 20 is formed but, conversely, a p-type silicon layer be used and n+ ions may be injected into the substrate to form an n+ piezoresistance.

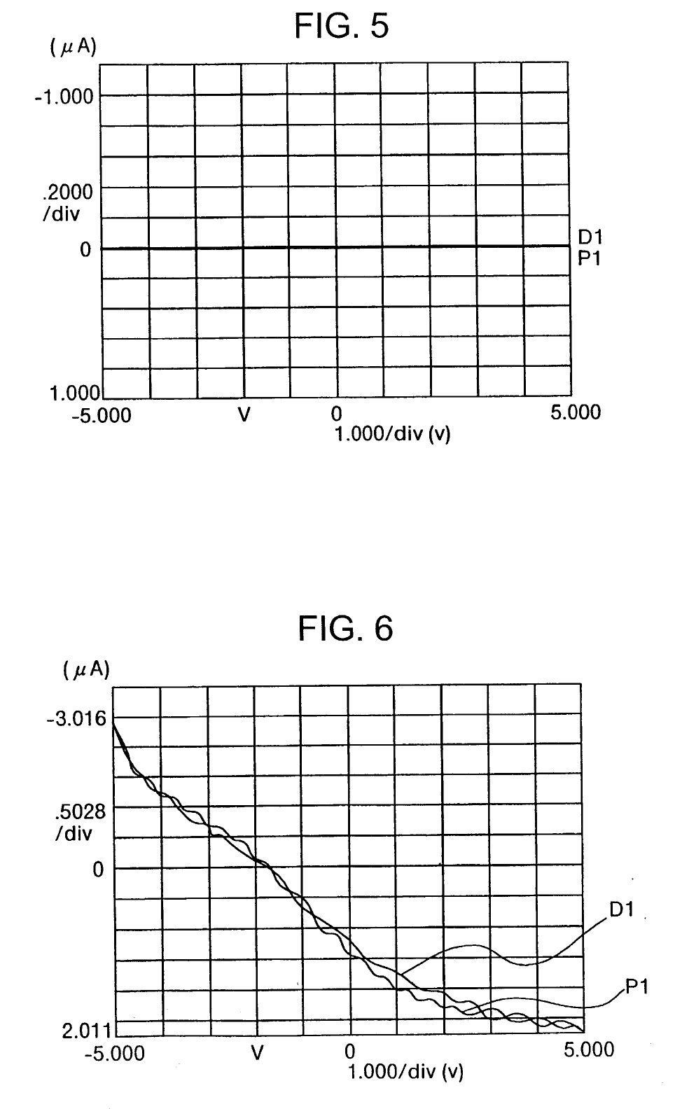

Next, characteristics when leakage current flowing between the conductor, the conductive film and the piezoresistance are described for the case of measuring without irradiating the surface of a sample with light (in the dark) and when measuring with the sample surface irradiated with light (in the light). A graph of current against voltage for between the conductor, conductive film and piezoresistance for an SPM probe of the first embodiment is shown in FIG. 5 and FIG. 6. This graph of current against voltage shows results for measurements taken under the same conditions as which the current against voltage graph described using FIG. 14 were taken. In FIG. 5 the units for the leakage current are expressed in the order of A, and in FIG. 6 the units for leakage current are expressed in the order of nA.

This current-voltage graph is plotted for measurements of leakage current with respect to voltage taking the current (A) as the vertical axis and the voltage V(V) as the horizontal axis, as with the related case described using FIG. 14. Specifically, in FIG. 1, a graph is shown for when leakage current flowing between the conductor 22, the conductive film 24 and the piezoresistance 20 is measured with a variable voltage being applied to the conductor 22 covering the tip 12 with the conductive layers 26 and 28 put to ground, i.e. with the piezoresistance 120 put to ground. The voltage can be varied between −5V and 5V.

In this I-V graph, changes from −5V to −5V are substantially the same in the order of A for a curve D for in the dark and a curve P for in the light (refer to FIG. 5). Looking in the order of nA's, for example, for a voltage of 5V, current is approximately 2,072 nA when dark and 2,135 nA in the light, giving substantially the same value. At −5V, a current of approximately 3,016 nA is exhibited both in the dark and in the light. Namely, from −5V to approximately −5V, there is a change of approximately 5 nA for both in the dark and in the light. However, this is a leakage current small enough to be ignored in order to obtain a spatial resolution of 100 nm or less. It can therefore be understood that the silicon oxide film 17 coated on the tip 12 provides insulation to such an extent that leakage current between the conductive film 22, the vicinity thereof, and the piezoresistance 20 can be reduced to a range that does not influence measurements.

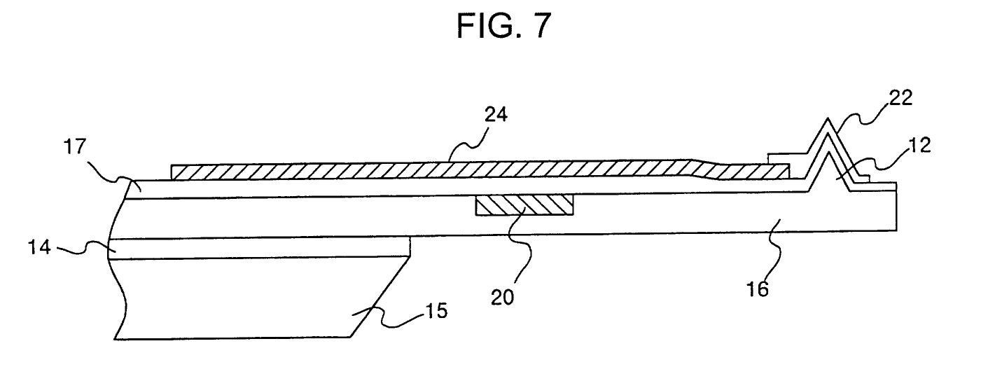

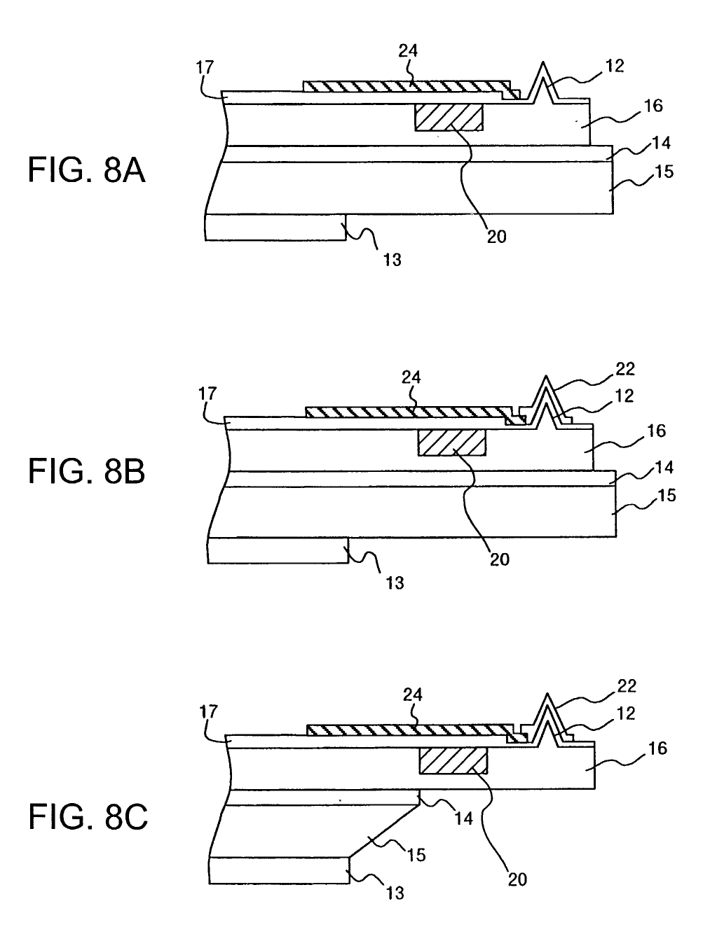

A description is now given of a modified example for connecting the conductive layer 24 and the conductive layer 22 shown in FIG. 3. A cross-sectional view taken along line B-B′ of FIG. 1 for the modified example for connecting the conductive layer 24 and the conductive layer 22 is shown in FIG. 7. The process for forming the SPM probe 10 in this case is shown in FIG. 8A-FIG. 8C. In this modified example, as shown in FIG. 7, a structure is adopted where electrical connection is made with the conductive film 22. by arranging the conductive layer 24 at a lower layer.

The same processes are carried out as described above in FIG. 4A-FIG. 4I and description thereof is omitted, with the processes from FIG. 4I onwards being described.

Continuing on from the process in FIG. 4I, as shown in FIG. 8A, the conductive layer 24 is formed from a metal such a aluminum (Al) etc. so as to be relatively thick from the tip 12, along the bending part and continuing on to the support unit, and in the vicinity of the conductive film 22. During this time, a portion positioned at the support unit of the piezoresistance 20 is not coated with the silicon oxide film 17. Aluminum (Al) etc. is embedded at this portion so as to form metal contacts 32 and 34 and conductive layers 26 and 28 are formed as wiring from the metal contacts 32 and 34 taking the silicon oxide film 17 as a lower layer (not shown).

Next, as shown in FIG. 8B, the surface and the outside edge of the silicon oxide film 17 of the tip 12 and one end of the conductive layer 24 are sputtered so as to be covered with relatively hard titanium (Ti) or platinum (Pt) so as to form the conductive film 22. One end positioned at the lever of the conductive layer 24 and one part of the conductive film 22 are electrically connected taking the conductive film 22 as an upper layer.

It is preferable for the thickness of the conductive film 22 to be thin to as great an extent as possible whereby the pointedness of the tip is not lost. For example, approximately 10 nm to 100 nm is preferable. A thickness of approximately 10 nm is a thickness where there is no electrical breakdown when a voltage of around 10V is applied across the sample and the tip 12. A thickness of approximately 100 nm is substantially the limit for obtaining a spatial resolution of approximately 100 nm for an atomic force microscope. A thickness of this range is thinner than the 500 nm to 800 nm thickness typically demanded as a thickness of a silicon oxide film formed on a semiconductor substrate.

Next, as shown in FIG. 8C, back-etching is carried out using a 40% potassium hydroxide solution (KOH+H2O) taking the patterned silicon oxide film 13 as a mask as shown in FIG. 4G, the semiconductor substrate 15 and embedded oxide layer 14 are removed in a localized manner, and an SPM probe 10 consisting of an SOI silicon layer 16 equipped with a piezoresistance 20 and a conductive layer 24 is formed. Here, p+ ions are injected into an n-type silicon layer 16 and a P+ piezoresistance 20 is formed but, conversely, a p-type silicon layer may be used and n+ ions may be injected into the substrate to form an n+ piezoresistance.

As described above, according to the first embodiment, a conductive film of the tip and the vicinity thereof are insulated from a piezoresistance by a silicon oxide film. Electrode wiring is then taken from the conductive layer covering the surface of the tip and is taken as one electrode so that when a voltage is applied across a sample constituting the other electrode and the tip, leakage current between the conductive layer of the tip, the vicinity thereof, and the piezoresistance can be made small compared to that of the related art. In particular, as described above, the leakage current in a bright environment where the sample is irradiated with light is a small value which is substantially the same as leakage current for when the sample is in the dark and is not irradiated with light. This means that data taken both in the light and in the dark can be compared.

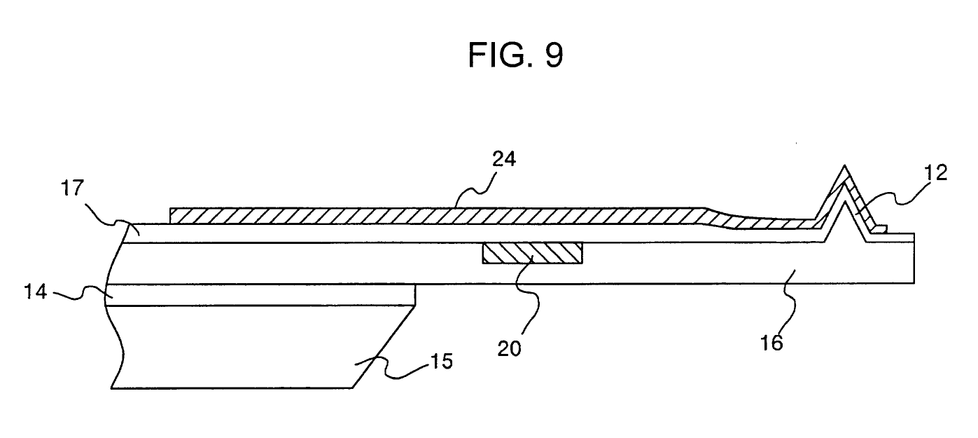

FIG. 9 is a cross-sectional view of self-detecting type SPM probe of a second embodiment of the present invention.

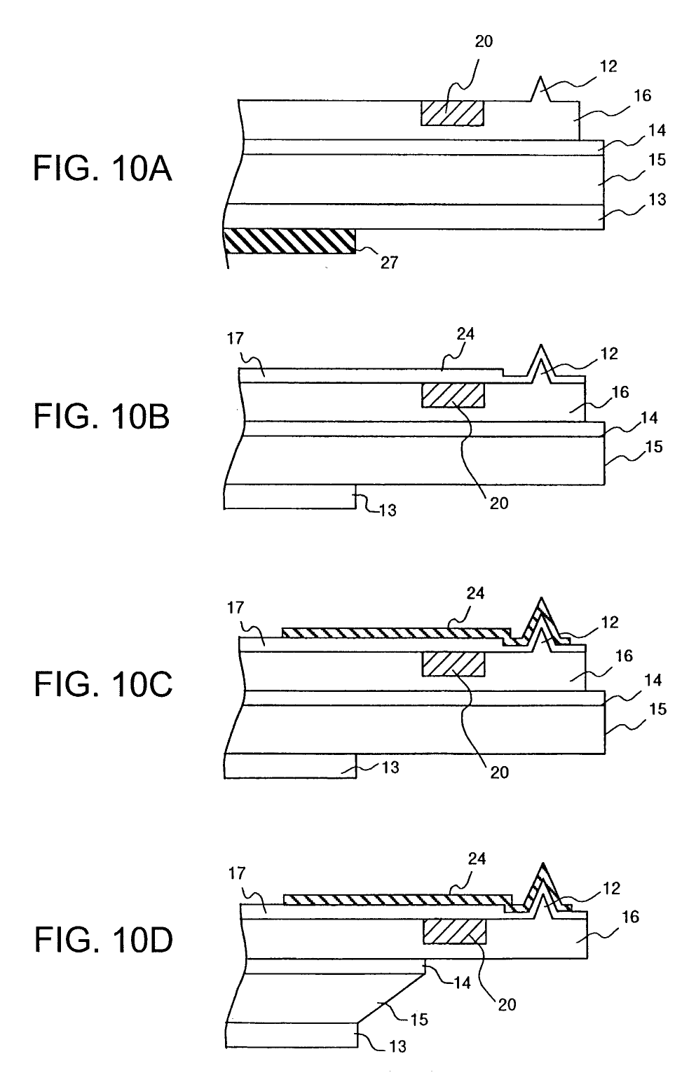

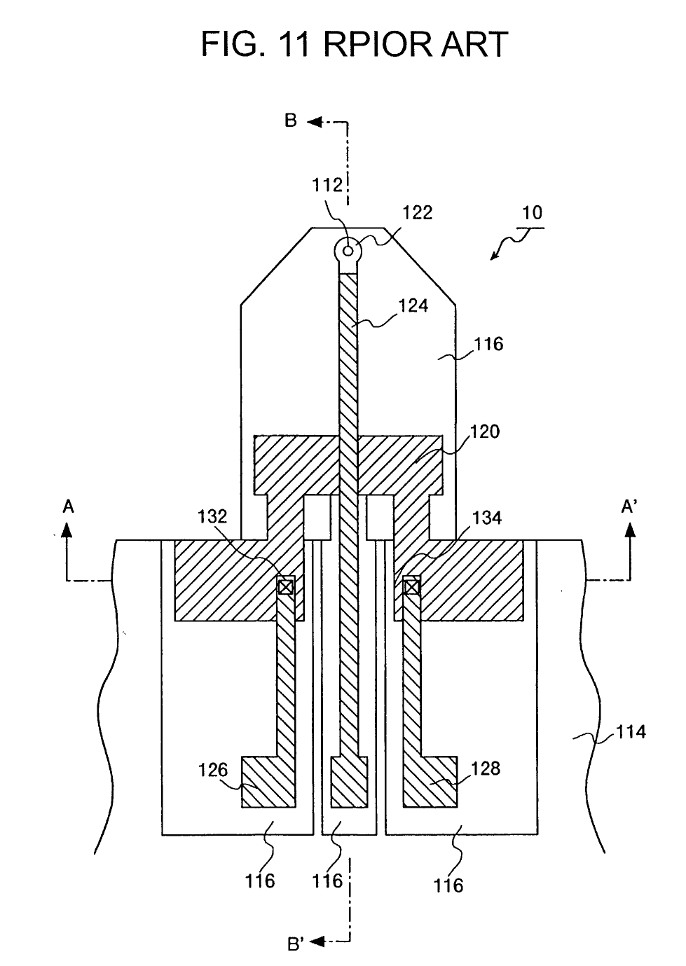

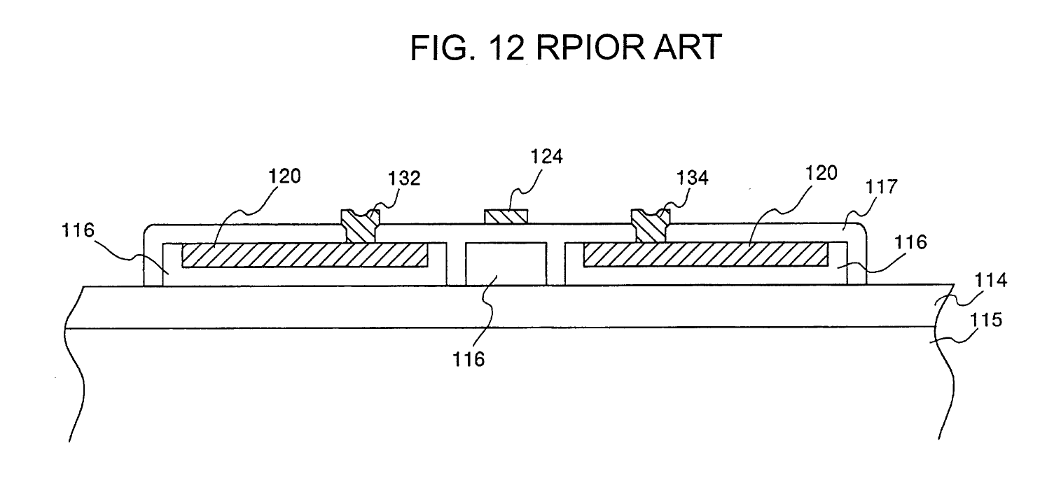

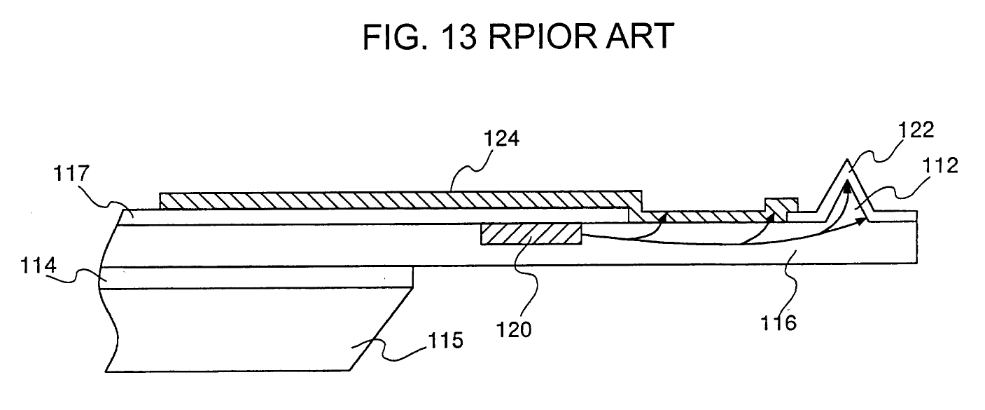

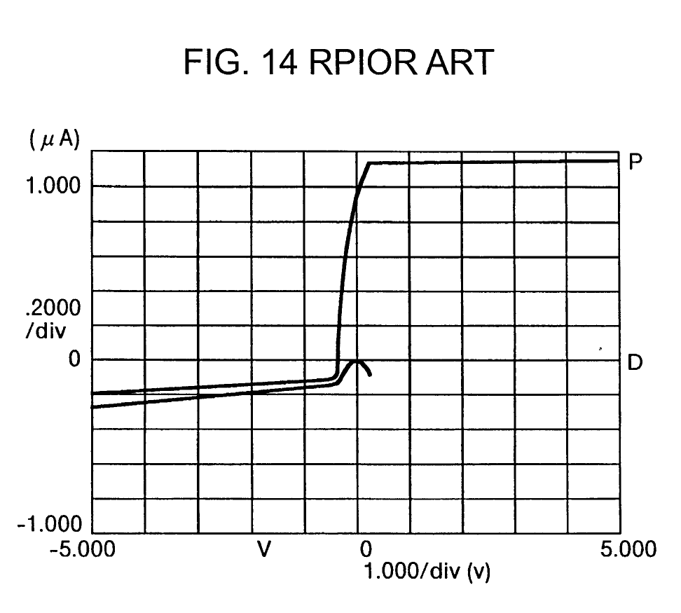

In the first embodiment, the conductive film 22 coated on the tip 12 and the conductive layer 24 wired from the conductive film 22 are formed using materials applied in different processes, but can, as shown in FIG. 9, also be formed integrally from the same type of material. The processes for forming the SPM probe 10 in this case are shown in FIG. 10A-FIG. 10D.

The same processes are carried out as described above in FIG. 4A-FIG. 4E and description thereof is therefore omitted, with the processes from FIG. 4E onwards being described.

Continuing from the process in FIG. 4E, a photoresist layer 25 is removed and a photoresist film 27 constituting an etching mask is formed above the rear surface side silicon oxide film (SiO2) 13, as shown in FIG. 10A. Back-etching is then carried out using buffered hydrofluoric acid (BHF) taking the photoresist film 27 as a mask and the silicon oxide film 13 is patterned.

Further, as shown in FIG. 10B, the silicon oxide film is coated on from the support part of the SOI silicon layer 16 to the region for forming the piezoresistance 20 at the lever and to the tip 12 so as to protect the surface.

Continuing on, as shown in FIG. 10C, a conductive layer 24 is formed of a metal such as aluminum (Al) from a portion of the silicon film 17 of the tip 12 along the silicon oxide film 17 on the side of the support unit. During this time, aluminum (Al) etc. is embedded at a portion positioned at the support unit of the piezoresistance 20 so as to form metal contacts 32 and 34 and conductive layers 26 and 28 are formed as wiring from the metal contacts 32 and 34 taking the silicon oxide film 17 as a lower layer (not shown).

Next, as shown in FIG. 10D, back-etching is carried out using a 40% potassium hydroxide solution (KOH+H2O) taking the patterned silicon oxide film 13 as a mask as shown in FIG. 10B, the semiconductor substrate 15 and embedded oxide layer 14 are removed in a localized manner, and an SPM probe 10 consisting of an SOI silicon layer 16 equipped with a piezoresistance 20 and a conductive layer 24 is formed.

As described above, according to the second embodiment, the surface of the tip can be given conductivity and electrode wiring can be formed from the tip surface in a one-time process. Measurement of the surface potential of the sample can therefore be achieved and selection of material for a conductive layer taken from the tip is possible. A cantilever etc. can then be provided based on the relationship between the sharpness of the tip and conductivity of the wiring taken from the tip, and the leakage current. A user can then select an appropriate cantilever according to the purpose of use or the sample to be observed.

As described in detail above, according to the self-detecting type SPM probe of this invention, a conductive film of the tip and the vicinity thereof are insulated from a piezoresistance by a silicon oxide film. Electrode wiring is then taken from the conductive layer covering the surface of the tip and is taken as one electrode so that when a voltage is applied across a sample constituting the other electrode and the tip, leakage current between the conductive layer of the tip, the vicinity thereof, and the piezoresistance that is small compared to that of the related art can be obtained. In particular, as described above, an SPM can be provided whereby the leakage current in a bright environment where the sample is irradiated with light is a small value which is substantially the same as leakage current for when the sample is in the dark and is not irradiated with light. This means that data taken both in the light and in the dark can be compared.

What is claimed is:

1. A self detecting type SPM probe formed from a lever provided with a cantilever comprising a sharpened tip at a front end thereof, a support unit supporting the lever, bending parts coupling the lever and the support unit, a piezoresistance formed in a U-shape provided on the cantilever so as to pass through the bending parts, a conductive film coated in the vicinity of the tip, an insulation layer formed on the piezoresistance and the support unit, and a conductive layer electrically connecting with the conductive film in the vicinity of the tip of the conductive film and overlaid so as to pass from the lever and through the bending parts so as to reach the support unit, characterized by an insulation layer being laminated between the conductive film, coating the tip and the vicinity of the tip, and the tip.

2. The self-detecting type SPM probe of claim 1, wherein the insulation layer laminated between the conductive layer, coating the tip and the vicinity of the tip, and the tip is an insulating layer formed on the piezoresistance and the support unit in an overlaid manner.

3. The self-detecting type SPM probe of claim 1, wherein the insulation layer laminated between the conductive layer, coating the tip and the vicinity of the tip, and the tip is an insulating layer formed on the piezoresistance and the support unit in a thin manner.

4. The self-detecting type SPM probe of claim 1, wherein a conductive layer is provided on the conductive film at a portion electrically connecting the conductive layer and the conductive film.

5. The self-detecting type SPM probe of claim 1, wherein a conductive layer is provided below the conductive film at a portion electrically connecting the conductive layer and the conductive film.

6. The self-detecting SPM probe of claim 1, wherein the conductive layer and the conductive film are laminated in an integral manner.

7. The self-detecting type SPM probe of claim 2, wherein the insulation layer laminated between the conductive layer, coating the tip and the vicinity of the tip, and the tip is an insulating layer formed on the piezoresistance and the support unit in a thin manner.
